(19) United States
(12) Patent Application Publication
(10) Pub. No.: US 2026/0203906 A1
(43) Pub. Date: Jul. 16, 2026

(54) SYSTEMS AND METHODS FOR DETERMINING A ROTATIONAL ADJUSTMENT FOR INTRAOPERATIVE IMAGE DATA

(71) Applicant: INTUITIVE SURGICAL OPERATIONS, INC., Sunnyvale, CA (US)

(72) Inventors: Serena H. Wong, Los Altos, CA (US); Shalv P. Madhani, Milpitas, CA (US); Andrea L. Oviedo Buitrago, San Francisco, CA (US); Randall L. Schlesinger, San Mateo, CA (US)

(21) Appl. No.: 19/445,294

(22) Filed: Jan. 9, 2026

Related U.S. Application Data
(60) Provisional application No. 63/743,989, filed on Jan. 10, 2025.

(51) Int. Cl. G06T 7/00; G06T 7/33; G06T 7/38

(52) U.S. Cl. CPC G06T 7/0014; G06T 7/33; G06T 7/38; G06T 2207/10021; G06T 2207/30096

(57) ABSTRACT

A system may comprise a flexible elongate device including a working channel and a radial acoustic imaging tool extendable within the working channel and rotationally constrained relative to the flexible elongate device by a reference mechanism. The radial acoustic imaging tool may include a directional indicator. The system may also include a controller configured to receive an acoustic image of a region of interest from the radial acoustic imaging tool. The acoustic image may include an image of the directional indicator. The controller may also be configured to dynamically search the acoustic image to identify the image of the directional indicator, determine a rotational adjustment of the acoustic image to align the image of the directional indicator relative to the reference mechanism, and display the acoustic image with the rotational adjustment.

### CROSS-REFERENCED APPLICATIONS

This application claims priority to and benefit of U.S. Provisional Application No. 63/743,989 filed Jan. 10, 2025 and entitled “Systems and Methods for Determining a Rotational Adjustment for Intraoperative Image Data,” which is incorporated by reference herein in its entirety.

### FIELD

The present disclosure relates to use of intraoperative image data, and more particularly to registering intraoperative image data to a known reference frame during a medical procedure.

### BACKGROUND

Minimally invasive medical techniques are intended to reduce the amount of tissue that is damaged during medical procedures, thereby reducing patient recovery time, discomfort, and harmful side effects. Such minimally invasive techniques may be performed through natural orifices in a patient anatomy or through one or more surgical incisions. Through these natural orifices or incisions, an operator may insert a minimally invasive medical instrument (including surgical, diagnostic, therapeutic, and/or biopsy instruments) to reach a target tissue location. One such minimally invasive technique is to use a flexible elongate device which can be inserted into anatomic passageways and navigated toward a target region within the patient anatomy. An imaging tool may extend from the flexible elongate device to perform an imaging procedure near the target region. Systems and methods are needed for registering the imaging data from the imaging tool with a reference frame of the flexible elongate device.

### SUMMARY

The following presents a simplified summary of various examples described herein and is not intended to identify key or critical elements or to delineate the scope of the claims.

Consistent with some examples, a system may comprise a flexible elongate device including a working channel and a radial acoustic imaging tool extendable within the working channel and rotationally constrained relative to the flexible elongate device by a reference mechanism. The radial acoustic imaging tool may include a directional indicator. The system may also include a controller configured to receive an acoustic image of a region of interest from the radial acoustic imaging tool. The acoustic image may include an image of the directional indicator. The controller may also be configured to dynamically search the acoustic image to identify the image of the directional indicator, determine a rotational adjustment of the acoustic image to align the image of the directional indicator relative to the reference mechanism, and display the acoustic image with the rotational adjustment.

In some examples, a method comprises receiving an acoustic image of a region of interest from a radial acoustic imaging tool. The radial acoustic imaging tool is extendable within a working channel of a flexible elongate device and rotationally constrained relative to the flexible elongate device by a reference mechanism. The radial acoustic imaging tool includes a directional indicator, and the acoustic image includes an image of the directional indicator. The method may also comprise dynamically searching the acoustic image to identify the image of the directional indicator, determining a rotational adjustment of the acoustic image to align the image of the directional indicator relative to the reference mechanism, and displaying the acoustic image with the rotational adjustment.

In some examples, a non-transitory machine-readable media stores instructions that, when run by one or more processors, cause the one or more processors to receive an acoustic image of a region of interest from a radial acoustic imaging tool. The radial acoustic imaging tool is extendable within a working channel of a flexible elongate device and rotationally constrained relative to the flexible elongate device by a reference mechanism. The radial acoustic imaging tool includes a directional indicator, and the acoustic image includes an image of the directional indicator The non-transitory machine-readable media also dynamically searches the acoustic image to identify the image of the directional indicator, determines a rotational adjustment of the acoustic image to align the image of the directional indicator relative to the reference mechanism, and displays the acoustic image with the rotational adjustment.

It is to be understood that both the foregoing general description and the following detailed description are illustrative and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIG. 1 illustrates an instrument system extended within an anatomic structure, according to some examples.

FIG. 2A illustrates an acoustic imaging tool extended from a flexible elongate device near a target anatomic region, according to some examples.

FIG. 2B illustrates an acoustic image generated by the acoustic imaging tool of FIG. 2A, according to some examples.

FIG. 3A illustrates an acoustic imaging tool including a tool key and a directional indicator, according to some examples.

FIGS. 3B and 3C are cross-sectional images of the acoustic imaging tool of FIG. 3A, according to some examples.

FIG. 3D is an alternative cross-sectional image of an acoustic imaging tool at a distal tip of a flexible elongate device, according to some examples.

FIG. 3E illustrates the acoustic imaging tool of FIG. 3A extended from a flexible elongate device near a target anatomic region, according to some examples.

FIG. 3F illustrates an acoustic image generated by the acoustic imaging tool of FIG. 2A, according to some examples.

FIG. 3G illustrates the acoustic image of FIG. 3E with a rotational adjustment.

FIG. 3H illustrates an interventional tool extended from the flexible elongate device of FIG. 3D, according to some examples.

FIG. 4 illustrates displayed articulation guidance for the flexible elongate device, according to some examples.

FIG. 5 is a flowchart illustrating a method for displaying an acoustic image with a rotational adjustment, according to some examples.

FIG. 6 is a flowchart illustrating a method for conducting an interventional procedure at a target region identified in an acoustic image, according to some examples.

FIG. 7 is a flowchart illustrating a method for updating a planned target location based on a target region identified in an acoustic image, according to some examples.

FIG. 8A illustrates an anatomic model with an original planned target region, according to some examples.

FIG. 8B illustrates an acoustic image including an identified target region, according to some examples.

FIG. 8C illustrates the anatomic model of FIG. 8A with a modified planned target region based on the acoustic image of FIG. 8B, according to some examples.

FIG. 9 illustrates a simplified diagram of a medical system, according to some examples.

FIG. 10A illustrates a simplified diagram of a medical instrument system, according to some examples.

FIG. 10B illustrates a simplified diagram of a medical instrument including a medical tool within a flexible elongate device, according to some examples.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The systems and methods disclosed in this document may be used to register intraoperative image data, including acoustic image data (such as endobronchial ultrasound (EBUS) or radial endobronchial ultrasound (REBUS)) or fluoroscopic image data, to a medical instrument reference frame during a medical procedure. The registration may be used to determine a spatial adjustment (e.g., rotational adjustment) of the intraoperative image data used in an application such as a navigational guidance, an anatomic model refinement, or an interventional procedure. For example, the registration may be used to refine a display of the intraoperative image data to provide clear and intuitive guidance for movement of the medical instrument within the patient anatomy. In other examples, the registration may be used to refine locations of an instrument, tool, anatomic structure, and/or a target in a model constructed from preoperative imaging. In other examples, the registered intraoperative image data may enhance spatial awareness and a sense of intuitiveness for an operator during an interventional medical procedure such as a biopsy. Other uses or applications of the registered intraoperative image data may also be used to enhance the accuracy and efficiency of a medical procedure. The systems and methods disclosed in this document may be suitable for use in, for example, surgical, exploratory, diagnostic, therapeutic, or any other type of medical procedure. However, any reference to medical or surgical instruments and medical or surgical methods is non-limiting, as the systems and methods disclosed herein may be suitable for non-medical purposes. The systems, instruments, and methods described herein may be used for animals, human cadavers, animal cadavers, portions of human or animal anatomy, non-surgical diagnosis, as well as for industrial systems, general or special purpose robotic systems, general or special purpose robot-assisted medical systems.

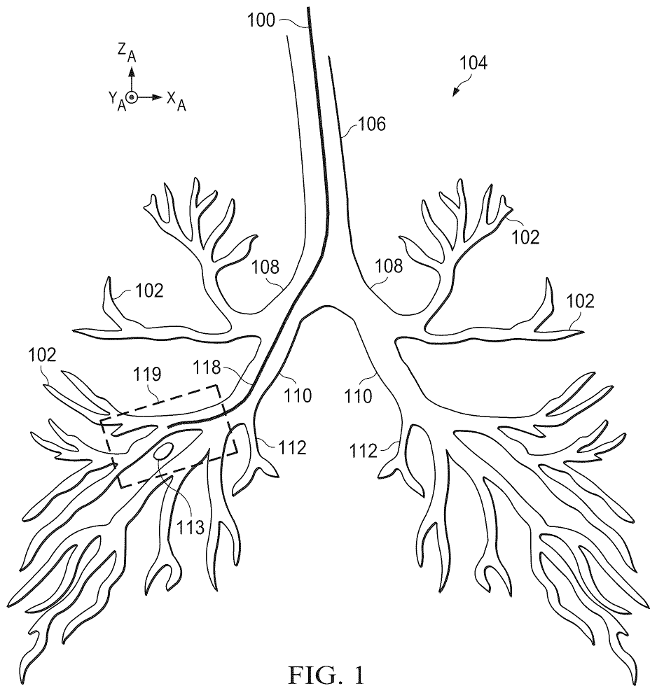

FIG. 1 illustrates an elongated medical instrument system 100 extending within branched anatomic passageways or airways 102 of an anatomic structure 104. In some examples the anatomic structure 104 may be a lung and the passageways 102 may include the trachea 105, primary bronchi 108, secondary bronchi 110, and tertiary bronchi 112. The anatomic structure 104 has an anatomical frame of reference (X_{A}, Y_{A}, Z_{A}). A distal end portion 118 of the medical instrument system 100 may be advanced into an anatomic opening (e.g., a patient mouth) and through the anatomic passageways 102 to perform a medical procedure, such as a biopsy, at or near a target tissue or lesion 113 in an anatomic region 119. The medical instrument system 100 may include, for example, a catheter or an endoscopic device. An endoscopic device may include a specialized endoscopic device such as a bronchoscope. In some examples, the medical instrument system 100 may include multiple elongate devices, such as an endoscopic device and one or more secondary imaging or interventional tools that may extend through the endoscopic device.

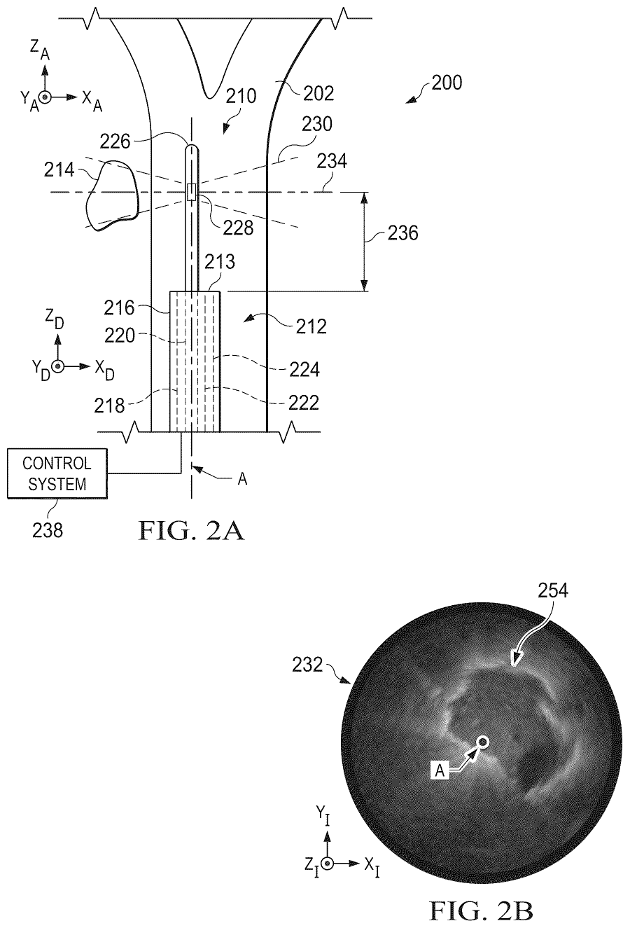

FIG. 2A illustrates an anatomic region 200 (e.g. the anatomic region 119) including an anatomic passageway 202 in which a medical instrument system 210 is extended. The medical instrument system 210 may include a flexible elongate device 212 located near a lesion 214 (e.g., the target tissue 113). In this example the lesion 214 may be located externally of the anatomic passageway 202, but in other examples the lesion may be within the anatomic passageway or may extend both internally and externally of the anatomic passageway. The anatomic region 200 may have an anatomical frame of reference (X_{A}, Y_{A}, Z_{A}), and the flexible elongate device 212 may have a device frame of reference (X_{D}, Y_{D}, Z_{D}). The anatomical and device frames of reference may be registered to each other or to a common frame of reference so that the position and/or orientation of at least a portion of the flexible elongate device 212 is known with respect to the anatomic region.

The flexible elongate device 212 may include a flexible elongate body 216 and an optical imaging system 218 extending within the flexible elongate body. The optical imaging system 218 may include, for example, a monoscopic or stereoscopic camera. In some examples, the optical imaging system 218 may be the optical imaging device of an endoscopic device such as a bronchoscope. In some examples, the optical imaging system 218 may include a light source to provide illumination of anatomic tissues and structures surrounding the optical imaging system. The optical imaging system 218 may be integral with or removable from the flexible elongate body 216. The flexible elongate device 212 may also include a working channel 220 extending through the flexible elongate body 216. Any of a variety of tools, instruments, devices, and/or fluids may be introduced or removed from the patient anatomy through the working channel 220 of the flexible elongate body 216.

In some examples, the flexible elongate device 212 may include a localization device 222 which may include a localization sensor such as an optical fiber shape sensor, an electromagnetic (EM) position sensor, or any other type of position, orientation, or shape sensor. The localization device 222 may be housed in the body 216 of the flexible elongate device 212 and may generate localization data used to localize the flexible elongate device 212 and the device frame of reference (X_{D}, Y_{D}, Z_{D}) relative to a registered frame of reference such as the anatomical frame of reference (X_{A}, Y_{A}, Z_{A}).

In some examples the flexible elongate device 212 may house an articulation system 224 which may include control members or cables (which may also be referred to as pull wires), linkages, or other actuation controls that may be operated to controllably bend a distal tip 213 of flexible elongate device 212. The articulation system 224 may have a fixed or known configuration in the flexible elongate device 212 and may control one or more degrees of freedom of motion (e.g., pitch and/or yaw) of the flexible elongate device 212 and the associated device frame of reference (X_{D}, Y_{D}, Z_{D}).

The medical instrument system 210 may also include an intraoperative imaging tool 226 extendable within the working channel 220. In some examples, the intraoperative imaging tool 226 may be an acoustic imaging tool that includes a transducer assembly 228. The transducer assembly 228 may include, for example, one or more ultrasonic transducers that may generate acoustic image data used to produce acoustic images, such as ultrasound images. The image data may be used to produce still or video images. A portion of the intraoperative imaging tool 226 including the transducer assembly 228 may be extendable distally beyond a distal end portion of the flexible elongate device 212. The intraoperative imaging tool 226 may be removable from the working channel 220.

In some examples, the intraoperative imaging tool 226 may be a radial acoustic imaging tool or probe, such as a radial endobronchial ultrasound (radial EBUS or REBUS) probe that may be rotationally and longitudinally moveable relative to the flexible elongate device 212. The transducer assembly 228 may include a mechanical radial scanning device that is rotated or spun about a longitudinal axis A of the intraoperative imaging tool 226 to capture radial image data. The transducer assembly 228 may be coupled to one or more electrical wires or optical fibers for a variety of functions including activating the ultrasound transducer, modulating its output, capturing return signals, and/or transmitting image data. The intraoperative imaging tool 226 may have an imaging field of view 230 that may be captured in an intraoperative image 232, as shown in FIG. 2B. An image 254 of the lesion 214 may be visible in the image 232. The image 232 may be an acoustic image such as a radial ultrasound image in a scan plane 234 with an image frame of reference (X_{I}, Y_{I}, Z_{I}). In some examples, the field of view 230 represents a scanning direction of the transducer assembly 228. In some examples, the scanning direction is a 360° circumferential field of view that is perpendicular to the longitudinal axis A of the intraoperative imaging tool 226. In some examples, the scan plane 234 and the transducer assembly 228 may be located at an insertion distance 236 from the distal tip 213 of the flexible elongate device 212. The insertion distance 236 may be known or measured by one or more markers, sensors, motor encoders, or other position determination techniques. The appearance of one or more objects in the field of view 230 may change as one or more of the position, orientation, and/or insertion distance of the transducer assembly 228 changes.

In some examples, the intraoperative imaging tool 226 may be removed from the working channel 220 and replaced with an interventional tool (e.g., interventional tool 370) which may be extendable through the working channel 220 and distally of the distal end of the flexible elongate device 212. The interventional tool may be selected to perform any of a variety of functions or procedures. For example, the interventional tool may include a catheter, a treatment tool, a biopsy tool, a sensor tool, or any other type of tool used in a medical intervention.

The medical instrument system 210 may also include a controller or control system 238. In some examples, the control system 238 may be a component of or operate in coordination with a control system of a robot-assisted medical system (e.g. the control system 912). The control system 238 may be used to control operation of any of the functions of the flexible elongate device 212, including processing image data from the optical imaging device 218 and the intraoperative imaging tool 226, controlling or processing information from the localization device 222, and/or processing motion commands through the articulation system 224.

In the example of medical instrument system 210, the relationship between the image 232 captured by the intraoperative imaging tool 226 and the flexible elongate device 212 may be unclear or unknown and thus the orientation for referencing or displaying the image 232 may be indeterminate. In other words, if the image frame of reference (X_{I}, Y_{I}, Z_{I}) is unknown or unregistered to the device frame of reference (X_{D}, Y_{D}, Z_{D}), the relationship of the image 232 to the optical imaging system 218 (and images generated thereby), the articulation system 224, the localization device 222, or other components of the flexible elongate device 212 may be unclear. As such, the endoscopic images generated by the optical imaging system 218 and the motions of the articulation system 224, one or both of which may provide an operator with spatial awareness or a sense of intuitive control, may have no clear relationship to the image 232. Without a clear relationship between the image 232 and the flexible elongate device 212, an operator may have difficulty moving the device quickly toward the target lesion. For example, the location of the lesion 214 relative to the flexible elongate device 212 may be unclear because the image 232 comprising the image 254 of the lesion 214 may have an indeterminate orientation when presented to an operator for viewing. Without a relationship between the intraoperative imaging tool 226 and the flexible elongate device 212, the image 232 may not provide clear guidance or contribute to the intuitiveness of moving the flexible elongate device 212 with respect to the image. Without clear image guidance, an operator's ability to navigate toward the lesion may be complicated or impaired.

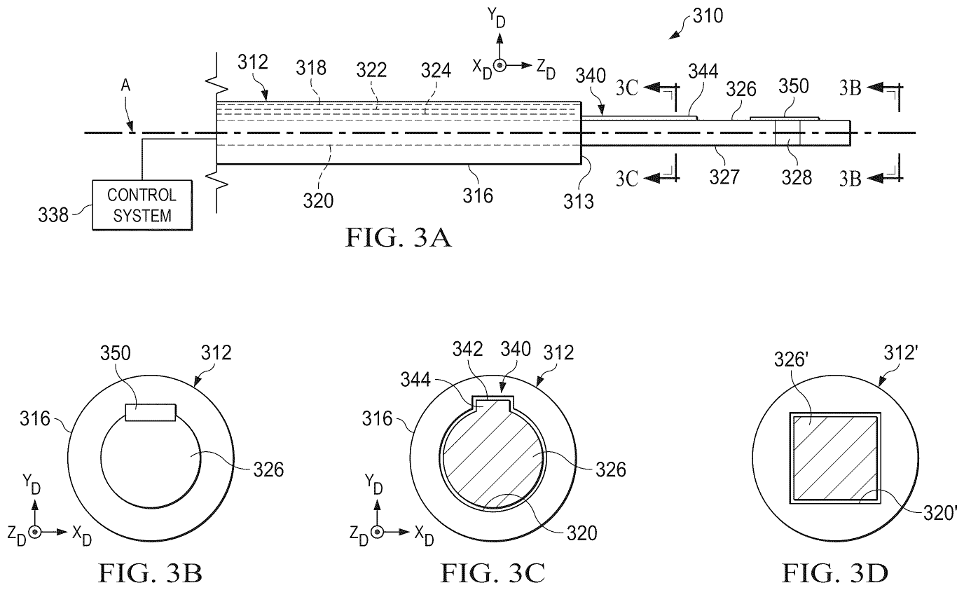

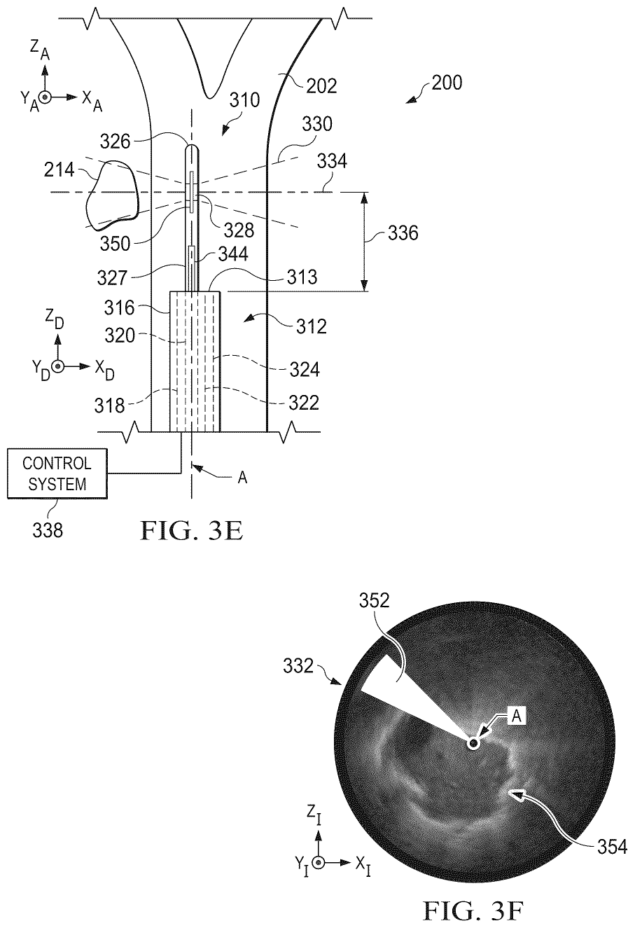

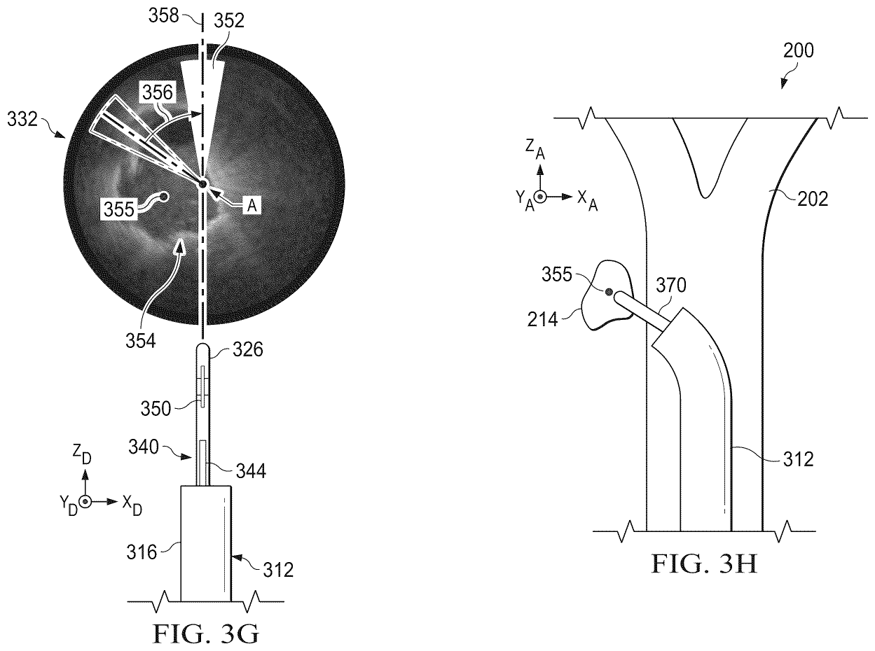

FIGS. 3A-3G illustrate a medical instrument system 310 that is configured to generate an intraoperative image 332 that may be registered to the device frame of reference (X_{D}, Y_{D}, Z_{D}) of a flexible elongate device 312. The registered intraoperative image data may be used for various applications such as displaying navigational guidance, refining an anatomic model, or conducting an interventional procedure.

As shown schematically in FIG. 3A, the medical instrument system 310 may include a flexible elongate device 312 with a device frame of reference (X_{D}, Y_{D}, Z_{D}). The flexible elongate device 312 may include a flexible elongate body 316 with an optical imaging system 318 which may be substantially similar to the optical imaging system 218. In some examples, the flexible elongate device 312 may include a localization device 322 which may be substantially similar to the localization device 222. In some examples the flexible elongate device 312 may house an articulation system 324 which may be substantially similar to the articulation system 224. The medical instrument system 310 may also include a controller or control system 338 which may be substantially similar to the control system 238.

The flexible elongate device 312 may also include a working channel 320 extending through the flexible elongate body 316. Any of a variety of tools, instruments, devices, and/or fluids may be introduced or removed from the patient anatomy through the working channel 320 of the flexible elongate body 316. As described in detail below, the working channel 320 may have a square or otherwise keyed cross-sectional shape at a proximal portion, a distal portion, or along a portion or full length of the body 306.

The medical instrument system 310 may also include an intraoperative imaging tool 326 extendable within the working channel 320. In some examples, the intraoperative imaging tool 326 may be an acoustic imaging tool that includes shaft 327 carrying a transducer assembly 328. The transducer assembly 328 may include, for example, one or more ultrasonic transducers that may generate acoustic image data used to produce acoustic images, such as ultrasound images. The image data may be used to produce still or video images. A portion of the intraoperative imaging tool 326 including the transducer assembly 328 may be extendable distally beyond a distal tip 313 of the flexible elongate device 312. The intraoperative imaging tool 326 may be removable from the working channel 320. The intraoperative imaging tool 326 may be a radial acoustic imaging tool or probe, such as a radial endobronchial ultrasound (radial EBUS or REBUS) probe that may be rotationally and longitudinally moveable relative to the flexible elongate device 312. The transducer assembly 328 may include a mechanical radial scanning device that is rotated or spun about a longitudinal axis A of the intraoperative imaging tool 326. The transducer assembly 328 may be coupled to one or more electrical wires or optical fibers for activating the ultrasound transducer, modulating its output, capturing return signals, and/or the like.

In some examples, the intraoperative imaging tool 326 may be removed from the working channel 320 and replaced with an interventional tool 370 (FIG. 3H) which may be extendable through the working channel 320 and distally of the distal tip 313 of the flexible elongate device 312. The interventional tool may be selected to perform any of a variety of functions or procedures. For example, the interventional tool may include a catheter, a treatment tool, a biopsy tool, a sensor tool, or any other type of tool used in a medical intervention.

The medical instrument system 310 may also include a reference system including a keyed reference mechanism 340 and a directional indicator 350 having a known orientation or radial position relative to the keyed reference mechanism 340. The keyed reference mechanism 340 may include a device key feature 342 and a mating tool key feature 344 to rotationally constrain motion of the intraoperative imaging tool 326 relative to the flexible elongate body 316. In some examples, the device key feature may include a physical feature of the working channel 320 such as an elongated slot, an elongated rail, or another type of projection, recessed feature, or cross-sectional shape that mates to a structure or shape of a corresponding tool key feature of the intraoperative imaging tool 326 along at least a portion of the length of the flexible elongate device 312. The keyed reference mechanism 340 may allow longitudinal motion of the intraoperative imaging tool 326 along the axis A relative to the flexible elongate body 316 while constraining rotational motion of the intraoperative imaging tool 326 about the axis A relative to the flexible elongate body 316. As shown in the cross-sectional view of FIG. 3C, medical instrument system 310 includes the reference mechanism 340 comprising a device key feature 342 in the form of an elongate groove in the inner wall of the working channel 320 and a tool key feature 344 in the form of an elongate ridge projecting from the shaft 327 of the intraoperative imaging tool 326. The elongate ridge 344 has a close fit within the elongate groove 342 allowing for relative longitudinal motion but constraining or restricting relative rotational motion. In an alternative example, the groove may extend in the intraoperative imaging tool and the ridge may project from a wall of the working channel. In an alternative example, as shown in FIG. 3D, a working channel 320′ may have a square cross-sectional shape that mates with an intraoperative imaging tool 326′ having a square cross-sectional shape. In this example, the outer shape of the tool may be a tool key feature and the wall of the working channel may be device key feature. Various interlocking cross-sectional shapes or mating keyed features may form device and tool key features. In various examples, the keyed reference mechanism may constrain rotational motion along a proximal portion of the working imaging tool, along a distal portion of the imaging tool, or along an entire length of the imaging tool. In some examples, a distal constraint may provide for a more accurate registration. In some examples, a proximal constraint may be suitable if the intraoperative imaging tool 326 (or a jacket of the tool) is generally, torsionally stiff.

As shown in FIGS. 3A and 3B, the directional indicator 350 of the reference system may include a marker longitudinally aligned with the keyed reference mechanism 340 or having a known radial position relative to the keyed reference mechanism 340. In various examples, the directional indicator 350 may include a wire, a filament, a balloon, an expandable member, a scaffolding, or any other structure or marker visible or detectable in the field of view of the transducer assembly 328. In various examples, the directional indicator may be formed from materials, such as titanium, stainless steel, or nitinol, that may be visible in ultrasound imaging. In various examples, the directional indicator 350 may include a unitary marker or a pattern including a plurality of markers that may remain stationary or fixed relative to the shaft 327 of the imaging tool 326 as the transducer assembly captures image data. In some examples, the directional indicator may be affixed directly to the intraoperative imaging tool 326, longitudinally spanning all or a portion of the field of view of the transducer assembly 328. In some examples, the directional indicator may be positioned on a jacket or oversheath that extends over the transducer assembly 328. The rotational motion of the directional indicator 350, and any jacket or oversheath to which it is affixed, may be constrained along with the intraoperative imaging tool 326 by the keyed reference mechanism 340 so that the directional indicator 350 may be in a known orientation with respect to the flexible elongate body 316. With a radially spinning transducer assembly 328 (e.g., radial EBUS), the rotation or radial position may not be otherwise registered to the flexible elongate body 316 and the speed, position, and/or indexing of the transducer assembly may change with anatomic tortuosity and pinching of the tool 326. Thus, including the directional indicator with the corresponding keyed reference mechanism, as described, may maintain the directional indicator, visible in the resulting image, in a known relationship to the flexible elongate body even as the transducer assembly is spinning.

As shown in FIG. 3E, the flexible elongate device 312 may be inserted into the anatomic passageway 202 and located near the lesion 214. The intraoperative imaging tool 326 may be extended through the working channel 320 and distally of the distal tip 313 of the flexible elongate device 312. The intraoperative imaging tool 326 may have an imaging field of view 330 that may be captured in an image 332, as shown in FIG. 3F. An image or mark 352 of the directional indicator 350 may be visible in the field of view image 332. The image 332 may be an acoustic image such as an ultrasound image in a scan plane 334 with an image frame of reference (X_{I}, Y_{I}, Z_{I}). In some examples, the field of view 330 represents a scanning direction of the transducer assembly 328. In some examples, the scanning direction is a 360° circumferential field of view that is perpendicular to the longitudinal axis A of the intraoperative imaging tool 326. In some examples, the scan plane 334 and the transducer assembly 328 may be at an insertion distance 336 from the distal tip 313 of the flexible elongate device 312. As the transducer assembly 328 spins and collects image data, the directional indicator 350 may be visible as a wedge shaped image 352 in the scanned image 332. In some examples, the image 352 may be brighter than the rest of the image. In other examples, the image 352 may be a darker shadow than the rest of the image. The appearance of the image 352 may depend on the material used to form the directional indicator 350 but may be distinguishable from the rest of the image. As described in greater detail below, the image 352 of the directional indicator 350 in the scanned image 332 and the reference mechanism 340 may be used to determine a rotational adjustment for registering or translating the image reference frame to the device reference frame. The medical instrument system 310 may also include a controller or control system 338 which may be similar to the control system 238. The control system 338 may be used to register the image reference frame reference (X_{I}, Y_{I}, Z_{I}) to the device reference frame reference (X_{D}, Y_{D}, Z_{D}).

FIG. 5 is a flowchart illustrating a method 500 for displaying an acoustic image with a rotational adjustment. The system 310 may be used in performing the method 500. At a process 502, an acoustic image of a region of interest may be received from a radial acoustic imaging tool. For example, the received acoustic image of a region of interest may be a radial ultrasound image such as the image 332 that includes an image 354 of a region of interest including the lesion 214 and the wedge shaped image 352 of the directional indicator 350.

At a process 504, the acoustic image may be dynamically searched to identify the mark or image of the directional indicator in the acoustic image. For example, the image 332 may be searched to identify the mark 352 corresponding to the directional indicator 350. Identifying the image 352 of the directional indicator 350 may include, for example, identifying the approximate boundaries of the mark or identifying a radius extending approximately centrally through the mark. In some examples, the image 352 of the directional indicator 350 may be identified using image analysis techniques performed by an image processor and/or a neural network. Dynamically searching the image 332 may include searching video acoustic imaging data as the imaging tool changes position and/or orientation due to motion (e.g., insertion/retraction, rotation, articulation) of the flexible elongate device 312 or motion (e.g., twisting, bending) of the imaging tool 326. In some examples, the image 352 of the directional indicator 350 may be identified by receiving an operator input indicating boundaries, a central radius, or other identifiers of the image 352.

At a process 506, a rotational adjustment of the acoustic image is determined to align the mark of the directional indicator with a reference mechanism. For example, as shown in FIG. 3G, a rotational adjustment 356 may be determined to align the image 352 of the directional indicator 350 relative to the reference mechanism 340. As previously described, the directional indicator 350 is aligned with or has a known orientation relative to the reference mechanism 340 and has a known orientation in the device frame of reference (X_{D}, Y_{D}, Z_{D}). As shown in FIG. 3G, the rotational adjustment 356 aligns the image 352 of the directional indicator 350 with an orientation associated with the reference mechanism 340 in the device frame of reference (X_{D}, Y_{D}, Z_{D}). The rotational adjustment 356 may be measured, for example, as an angle that the image 352 of the directional indicator 350 is rotated (e.g., compared the orientation of the image 352 of the directional indicator 350 in FIG. 3F) to align with the orientation of the reference mechanism 340. For example, in FIG. 3G, the rotational adjustment 356 may align the image 352 of the directional indicator 350 in a direction (e.g., in the 12 o'clock direction) associated with a positive pitch degree of freedom of motion (Y_{D}, Z_{D} plane) in the device frame of reference (X_{D}, Y_{D}, Z_{D}). With the image 332 rotated by the rotational adjustment 356, the relationship of the image frame of reference (X_{I}, Y_{I}, Z_{I}) to the device frame of reference (X_{D}, Y_{D}, Z_{D}) may be calculated or registered. With the image frame of reference (X_{I}, Y_{I}, Z_{I}) registered to the device frame of reference (X_{D}, Y_{D}, Z_{D}), the orientation of the lesion 214 (shown in the image 332 as lesion image 354) may be known relative device frame of reference (X_{D}, Y_{D}, Z_{D}).

In various examples, the rotational adjustment may be dynamic, changing in response to twisting and insertion of the spinning transducer assembly of the acoustic imaging tool. In some examples, the rotational adjustment 356 may be determined by the control system 338. In some examples, the rotational adjustment 356 may be determined by a user manipulating the displayed image 332 to bring the image 352 of the directional indicator 350 into alignment with a guide 358 aligned with a direction of the reference mechanism 340. In this example, the guide 358 may be in the 12 o'clock orientation associated with the positive pitch degree of freedom of motion of the flexible elongate device 312 in the device frame of reference. In other examples, the directional indicator may be aligned in another pre-determined direction associated with another known degrees of freedom of motion in the device frame of reference.

At a process 508, the acoustic image may be displayed with the rotational adjustment. For example, image 332 may be displayed in the rotated configuration as shown in FIG. 3G. The registered image 332 may provide an operator with an intuitive sense of the spatial correlation between the lesion 214 depicted in the acoustic image 332, tissue depicted in images produced by the optical imaging system 318, and the motion of the articulation system 324. In some examples, display of the rotated acoustic image may be omitted.

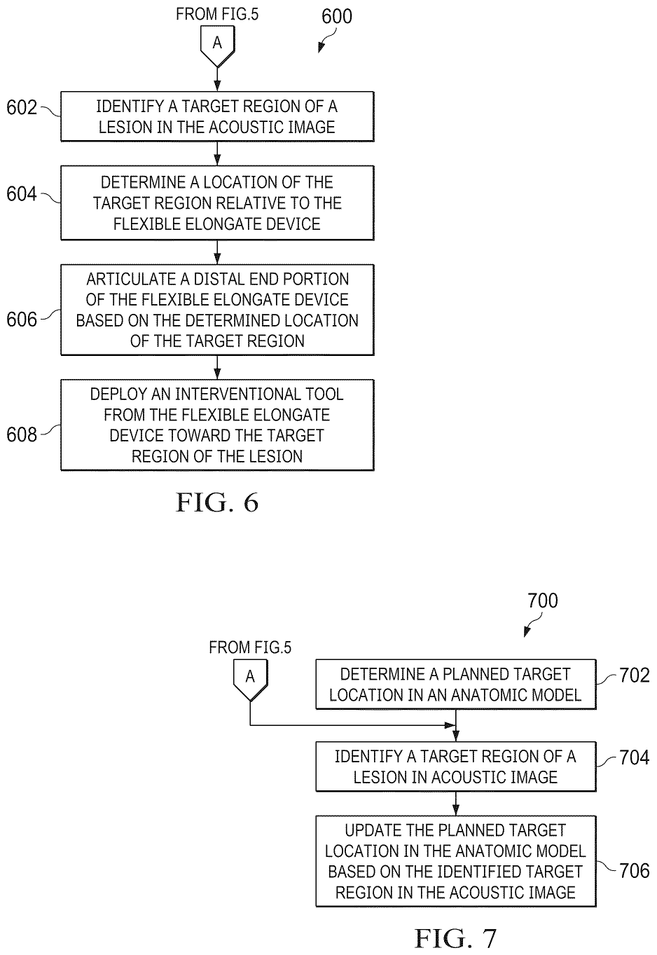

With the acoustic image in a known relationship to the reference frame of the flexible elongate device, various interventional or planning procedures may be performed. FIG. 6 is a flowchart illustrating a method 600 for conducting an interventional procedure at a target region identified in an acoustic image. All or portions of the method 600 may be performed after determination of the rotational adjustment to register the acoustic image, as described in method 500. The system 310 may be used in performing the method 600 as shown in FIG. 3H. At a process 602, a target region may be identified in the acoustic image. The target region may be within a lesion of interest for an interventional procedure such as a biopsy or a treatment. For example, a target region 355 may be identified in the image 354 of the lesion 214 as shown in FIG. 3G. In some examples, the target region 355 may be in the center of the image 354 of the lesion 214. In some examples, a plurality of target regions may be identified in various locations in the lesion 214. In some examples, the target region may be identified and/or marked by a clinician. In other examples, the target region may be identified and/or marked with computerized image analysis.

At a process 604, a location of the target region may be determined relative to the flexible elongate device. For example, the location of the target region 355 may be determined relative to the flexible elongate device 312 so that an interventional tool 370 (e.g., a biopsy tool) may be deployed from the working channel 320 in the direction of the target region 355, as shown in FIG. 3H.

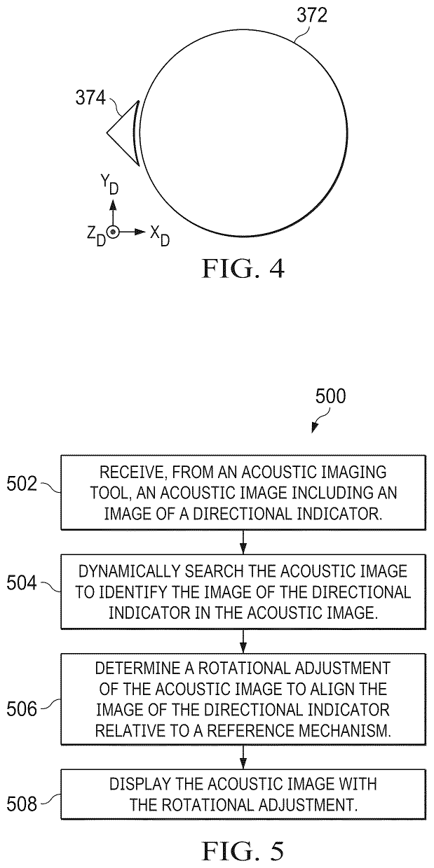

At a process 606, a distal end portion of the flexible elongate device may be articulated based on the determined location of the target region. For example, as shown in FIG. 3H, the distal end portion of the flexible elongate device 312 may be articulated, using the articulation system 324, based on the determined location of the target region 355 to aim the interventional tool 370 toward the target region 355. Optionally, as shown in FIG. 4, articulation guidance 372 may be displayed on a display system (e.g., display system 910), to assist an operator with aiming the interventional tool 370 and articulating the articulation system 324. The articulation guidance 372 may include an arrow 374 or directional guidance that indicates to an operator a direction for articulating the flexible elongate device 312.

At a process 608, the interventional tool may be deployed from the flexible elongate device toward the target region of the lesion. For example, as shown in FIG. 3H, the interventional tool 370 may be deployed from the flexible elongate device 312 toward the target region 355 in the lesion 214. In some examples, the interventional tool 370 may include a biopsy tool to biopsy the lesion at the target region or may include a treatment tool to treat the lesion at the target region.

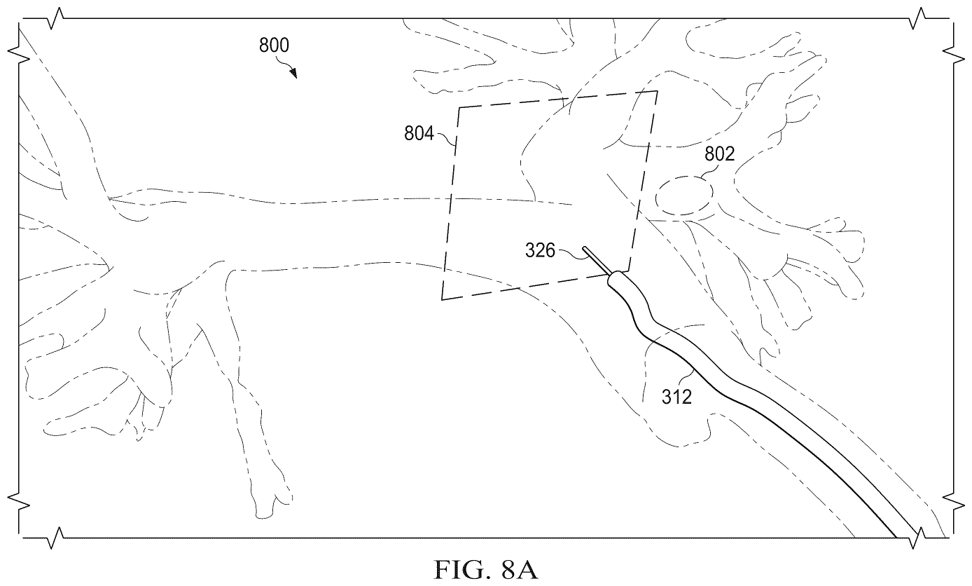

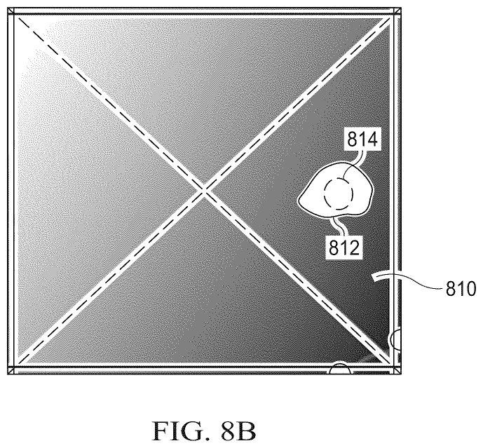

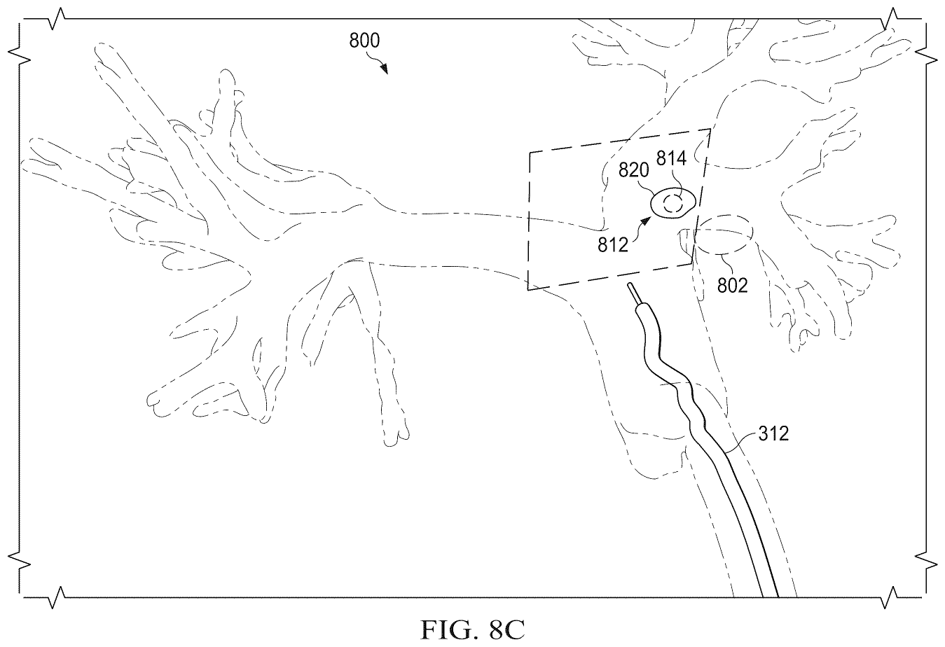

FIG. 7 is a flowchart illustrating a method 700 for updating a planned target location based on a target region identified in an acoustic image. All or portions of the method 700 may be performed after determination of the rotational adjustment to register acoustic image, as described in method 500. The system 310 may be used in performing the method 700 as further illustrated in FIGS. 8A-8C. At a process 702, a planned target location may be determined in an anatomic model. The model may be generated pre-operatively or intra-operatively from image data created using computed tomography (CT), magnetic resonance imaging (MRI), positron emission tomography (PET), fluoroscopy, thermography, ultrasound, optical coherence tomography (OCT), thermal imaging, impedance imaging, laser imaging, nanotube X-ray imaging, and/or the like. In some examples, the anatomic model may be a generic model. In the example of FIG. 8A, an anatomic model 800 may have an original planned target region 802. Optionally, the model 800 and the planned target region 802 may be displayed on a display system (e.g. display system 910). In some examples, the model 800 may be registered with the frame of reference of the flexible elongate device 312, and the device may be displayed with the model 800 on the display. As previously described, the intraoperative imaging tool 326 may be deployed from the flexible elongate device 312 to generate an acoustic image in an image plane 804.

At a process 704, a target region of a lesion may be identified in an acoustic image. For example, as shown in FIG. 8B, an acoustic image 810 (e.g., the image 332) in the image plane 804 may be registered to the frame of reference of the flexible elongate device 312, as previously described. The image 810 may include an image of a lesion 812 and an identified target region 814 in the lesion. In some examples, the target region 814 may be in the center of the lesion 812. In some examples, a plurality of target regions may be identified in various locations in the lesion 812. In some examples, the target region may be identified and/or marked by a clinician. In other examples, the target region may be identified and/or marked with computerized image analysis.

At a process 706, the planned target location in the anatomic model may be updated based on the identified target region in the acoustic image. For example, as shown in FIG. 8C, the anatomic model 800 may be updated with a modified planned target region 820 based on the acoustic image 810. The modified planned target region 820 may provide a more accurate representation of the location of the lesion 812 relative to the model and the flexible elongate device. Updating the planned target region may include determining an insertion distance (e.g. distance 336) of the intraoperative imaging tool 326 beyond a distal tip of the flexible elongate device 312.

In some examples, the acoustic image and/or the updated model may be displayed on a display system. The displayed updated model may include the image of lesion 812 at the modified planned target region 820. Optionally, the display of the original planned target region 802 may be omitted when the modified planned target region 820 is displayed. In some examples, an interventional marker (e.g., a graphical character) may be located in the acoustic image and/or the updated model to mark the identified target region or a location of the deployment of the interventional tool.

In some examples, an interventional too (e.g., tool 370) may be deployed from the flexible elongate device toward the modified planned target region. In some examples, an interventional marker, such as a biopsy marker, may be placed at the updated planned target location. In some examples, multiple two dimensional acoustic images may be used to form a three-dimensional volume of the lesion. The three-dimensional volume of the lesion may be graphically segmented and used to generate the modified planned target region. In some examples, a plurality of two-dimensional acoustic images may be segmented over time. The segmented images of the lesion may be used to create a three-dimensional volume that may be used to generate the modified planned target region.

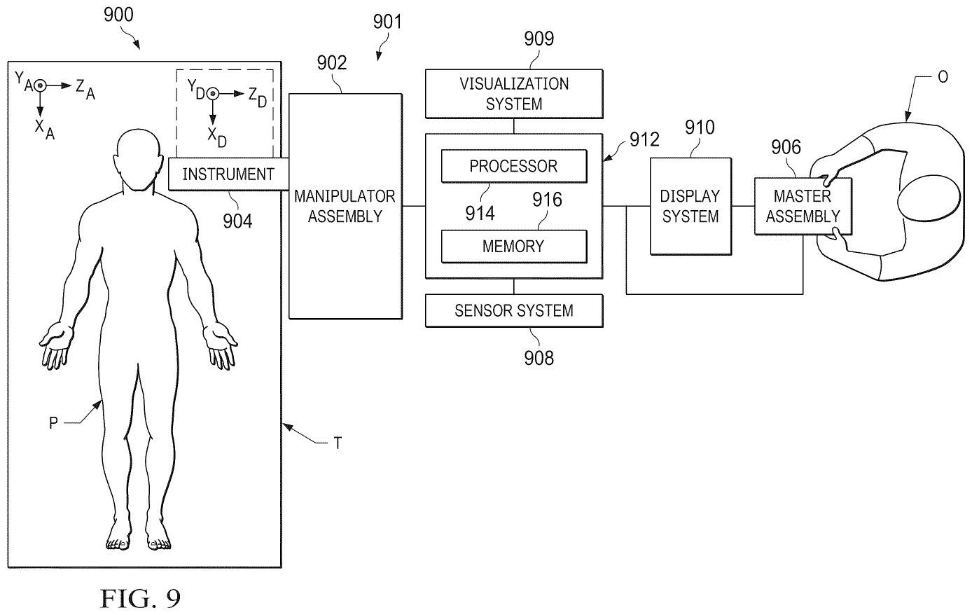

In some examples the medical instrument system 310 may be a component of a medical system 900 as illustrated in FIG. 9. The medical system 900 that may include a manipulator assembly 902 that controls the operation of a medical instrument 904, such the medical instrument system 310, in performing various procedures on a patient P. Medical instrument 904 may extend into an internal site within the body of patient P via an opening in the body of patient P. The manipulator assembly 902 may be robot-assisted, non-assisted, or a hybrid robot-assisted and non-assisted assembly with select degrees of freedom of motion that may be motorized and/or robot-assisted and select degrees of freedom of motion that may be non-motorized and/or non-assisted. The manipulator assembly 902 may be mounted to and/or positioned near a patient table T. A master assembly 906 allows an operator O (e.g., a surgeon, a clinician, a physician, or other user) to control the manipulator assembly 902. In some examples, the master assembly 906 allows the operator O to view the procedural site or other graphical or informational displays. In some examples, the manipulator assembly 902 may be excluded from the medical system 900 and the instrument 904 may be controlled directly by the operator O. In some examples, the manipulator assembly 902 may be manually controlled by the operator O. Direct operator control may include various handles and operator interfaces for hand-held operation of the instrument 904.

The master assembly 906 may be located at a surgeon's console which is in proximity to (e.g., in the same room as) a patient table T on which patient P is located, such as at the side of the patient table T. In some examples, the master assembly 906 is remote from the patient table T, such as in in a different room or a different building from the patient table T. The master assembly 906 may include one or more control devices for controlling the manipulator assembly 902. The control devices may include any number of a variety of input devices, such as joysticks, trackballs, scroll wheels, directional pads, buttons, data gloves, trigger-guns, hand-operated controllers, voice recognition devices, motion or presence sensors, and/or the like.

The manipulator assembly 902 supports the medical instrument 904 and may include a kinematic structure of links that provide a set-up structure. The links may include one or more non-servo controlled links (e.g., one or more links that may be manually positioned and locked in place) and/or one or more servo controlled links (e.g., one or more links that may be controlled in response to commands, such as from a control system 912). The manipulator assembly 902 may include a plurality of actuators (e.g., motors) that drive inputs on the medical instrument 904 in response to commands, such as from the control system 912. The actuators may include drive systems that move the medical instrument 904 in various ways when coupled to the medical instrument 904. For example, one or more actuators may advance medical instrument 904 into a naturally or surgically created anatomic orifice. Actuators may control articulation of the medical instrument 904, such as by moving the distal end (or any other portion) of medical instrument 904 in multiple degrees of freedom. These degrees of freedom may include three degrees of linear motion (e.g., linear motion along the X, Y, Z Cartesian axes) and in three degrees of rotational motion (e.g., rotation about the X, Y, Z Cartesian axes). One or more actuators may control rotation of the medical instrument about a longitudinal axis. Actuators can also be used to move an articulable end effector of medical instrument 904, such as for grasping tissue in the jaws of a biopsy device and/or the like or may be used to move or otherwise control tools (e.g., imaging tools, ablation tools, biopsy tools, electroporation tools, etc.) that are inserted within the medical instrument 904.

The medical system 900 may include a sensor system 908 with one or more sub-systems for receiving information about the manipulator assembly 902 and/or the medical instrument 904. Such sub-systems may include a position sensor system (e.g., that uses electromagnetic (EM) sensors or other types of sensors that detect position or location); a shape sensor system for determining the position, orientation, speed, velocity, pose, and/or shape of a distal end and/or of one or more segments along a flexible body of the medical instrument 904; a visualization system 909 (e.g., using an optical imaging device, an infrared imaging device, an ultrasound imaging device, an x-ray imaging device, a fluoroscopic imaging device, a computed tomography (CT) imaging device, a magnetic resonance imaging (MRI) imaging device, or some other type of imaging device) for capturing images, such as from the distal end of medical instrument 904 or from some other location; and/or actuator position sensors such as resolvers, encoders, potentiometers, and the like that describe the rotation and/or orientation of the actuators controlling the medical instrument 904.

The medical system 900 may include a display system 910 for displaying an image or representation of the procedural site and the medical instrument 904. Display system 910 and master assembly 906 may be oriented so physician O can control medical instrument 904 and master assembly 906 with the perception of telepresence.

In some embodiments, the medical instrument 904 may include a visualization system 909, which may include an image capture assembly that records a concurrent or real-time image of a procedural site and provides the image to the operator O through one or more displays of display system 910. The image capture assembly may include various types of imaging devices. The concurrent image may be, for example, a two-dimensional image or a three-dimensional image captured by an endoscope positioned within the anatomical procedural site. In some examples, the visualization system may include endoscopic components that may be integrally or removably coupled to medical instrument 904. Additionally or alternatively, a separate endoscope, attached to a separate manipulator assembly, may be used with medical instrument 904 to image the procedural site. The visualization system may be implemented as hardware, firmware, software or a combination thereof which interact with or are otherwise executed by one or more computer processors, such as of the control system 912.

Display system 910 may also display an image of the procedural site and medical instruments, which may be captured by the visualization system. In some examples, the medical system 900 provides a perception of telepresence to the operator O. For example, images captured by an imaging device at a distal portion of the medical instrument 904 may be presented by the display system 910 to provide the perception of being at the distal portion of the medical instrument 904 to the operator O. The input to the master assembly 906 provided by the operator O may move the distal portion of the medical instrument 904 in a manner that corresponds with the nature of the input (e.g., distal tip turns right when a trackball is rolled to the right) and results in corresponding change to the perspective of the images captured by the imaging device at the distal portion of the medical instrument 904. As such, the perception of telepresence for the operator O is maintained as the medical instrument 904 is moved using the master assembly 906. The operator O can manipulate the medical instrument 904 and hand controls of the master assembly 906 as if viewing the workspace in substantially true presence, simulating the experience of an operator that is physically manipulating the medical instrument 904 from within the patient anatomy.

In some examples, the display system 910 may present virtual images of a procedural site that are created using image data recorded pre-operatively or intra-operatively, such as image data created using computed tomography (CT), magnetic resonance imaging (MRI), positron emission tomography (PET), fluoroscopy, thermography, ultrasound, optical coherence tomography (OCT), thermal imaging, impedance imaging, laser imaging, nanotube X-ray imaging, and/or the like. The virtual images may include two-dimensional, three-dimensional, or higher-dimensional (e.g., including, for example, time based or velocity-based information) images. In some examples, one or more models are created from pre-operative or intra-operative image data sets and the virtual images are generated using the one or more models.

In some examples, for purposes of imaged guided medical procedures, display system 910 may display a virtual image that is generated based on tracking the location of medical instrument 904. For example, the tracked location of the medical instrument 904 may be registered (e.g., dynamically referenced) with the model generated using the pre-operative or intra-operative images, with different portions of the model correspond with different locations of the patient anatomy. As the medical instrument 904 moves through the patient anatomy, the registration is used to determine portions of the model corresponding with the location and/or perspective of the medical instrument 904 and virtual images are generated using the determined portions of the model. This may be done to present the operator O with virtual images of the internal procedural site from viewpoints of medical instrument 904 that correspond with the tracked locations of the medical instrument 904.

The medical system 900 may also include the control system 912, which may include processing circuitry that implements the some or all of the methods or functionality discussed herein. The control system 912 may include at least one memory 916 and at least one processor 914 for controlling the operations of the manipulator assembly 902, the medical instrument 904, the master assembly 906, the sensor system 908, and/or the display system 910. Control system 912 may include instructions (e.g., a non-transitory machine-readable medium storing the instructions) that when executed by the at least one processor, configures the one or more processors to implement some or all of the methods or functionality discussed herein. While the control system 912 is shown as a single block in FIG. 9, the control system 912 may include two or more separate data processing circuits with one portion of the processing being performed at the manipulator assembly 902, another portion of the processing being performed at the master assembly 906, and/or the like. In some examples, the control system 912 may include other types of processing circuitry, such as application-specific integrated circuits (ASICs) and/or field-programmable gate array (FPGAs). The control system 912 may be implemented using hardware, firmware, software, or a combination thereof.

In some examples, the control system 912 may receive feedback from the medical instrument 904, such as force and/or torque feedback. Responsive to the feedback, the control system 912 may transmit signals to the master assembly 906. In some examples, the control system 912 may transmit signals instructing one or more actuators of the manipulator assembly 902 to move the medical instrument 904. In some examples, the control system 912 may transmit informational displays regarding the feedback to the display system 910 for presentation or perform other types of actions based on the feedback.

The control system 912 may include a virtual visualization system to provide navigation assistance to operator O when controlling the medical instrument 904 during an image-guided medical procedure. Virtual navigation using the virtual visualization system may be based upon an acquired pre-operative or intra-operative dataset of anatomic passageways of the patient P. The control system 912 or a separate computing device may convert the recorded images, using programmed instructions alone or in combination with operator inputs, into a model of the patient anatomy. The model may include a segmented two-dimensional or three-dimensional composite representation of a partial or an entire anatomic organ or anatomic region. An image data set may be associated with the composite representation. The virtual visualization system may obtain sensor data from the sensor system 908 that is used to compute an (e.g., approximate) location of the medical instrument 904 with respect to the anatomy of patient P. The sensor system 908 may be used to register and display the medical instrument 904 together with the pre-operatively or intra-operatively recorded images. For example, PCT Publication WO 2016/191298 (published Dec. 1, 2016 and titled “Systems and Methods of Registration for Image Guided Surgery”), which is incorporated by reference herein in its entirety, discloses example systems.

During a virtual navigation procedure, the sensor system 908 may be used to compute the (e.g., approximate) location of the medical instrument 904 with respect to the anatomy of patient P. The location can be used to produce both macro-level (e.g., external) tracking images of the anatomy of patient P and virtual internal images of the anatomy of patient P. The system may include one or more electromagnetic (EM) sensors, fiber optic sensors, and/or other sensors to register and display a medical instrument together with pre-operatively recorded medical images. For example, U.S. Pat. No. 8,900,131 (filed May 13, 2011 and titled “Medical System Providing Dynamic Registration of a Model of an Anatomic Structure for Image-Guided Surgery”), which is incorporated by reference herein in its entirety, discloses example systems.

Medical system 900 may further include operations and support systems (not shown) such as illumination systems, steering control systems, irrigation systems, and/or suction systems. In some embodiments, the medical system 900 may include more than one manipulator assembly and/or more than one master assembly. The exact number of manipulator assemblies may depend on the medical procedure and space constraints within the procedural room, among other factors. Multiple master assemblies may be co-located or they may be positioned in separate locations. Multiple master assemblies may allow more than one operator to control one or more manipulator assemblies in various combinations.

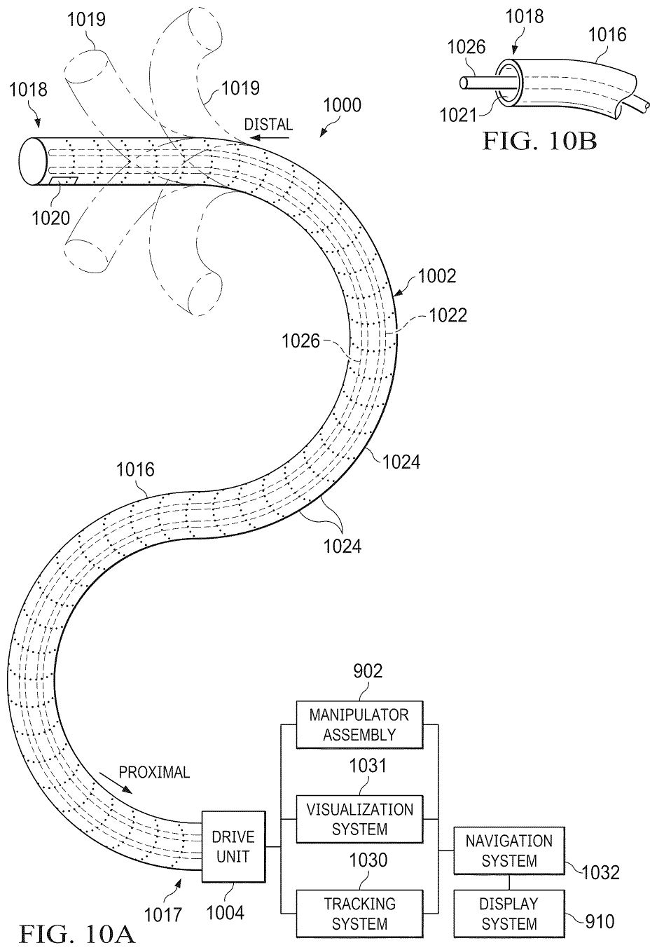

FIG. 10A is a simplified diagram of a medical instrument system 1000 according to some embodiments. The medical instrument system 1000 includes a flexible elongate device 1002 (e.g. medical instrument system 310), a drive unit 1004, and a medical tool 1026 that collectively is an example of the medical instrument 904 of the medical system 900. The medical system 1000 may be a robot-assisted system, a non-robot-assisted system, or a hybrid robot-assisted and non-assisted system, as explained with reference to FIG. 9. A visualization system 1031, tracking system 1030, and navigation system 1032 are also shown in FIG. 10A and are example components of the control system 912 of the medical system 900. In some examples, the medical instrument system 1000 may be used for non-robot-assisted exploratory procedures or in procedures involving traditional manually operated medical instruments, such as endoscopy. The medical instrument system 1000 may be used to gather (e.g., measure) a set of data points corresponding to locations within anatomic passageways of a patient, such as patient P.

The elongate device 1002 is coupled to the drive unit 1004. The elongate device 1002 includes a lumen or channel 1021 through which the medical tool 1026 may be inserted. The elongate device 1002 navigates within patient anatomy to deliver the medical tool 1026 to a procedural site. The elongate device 1002 includes a flexible body 1016 having a proximal end 1017 and a distal end 1018. In some examples, the flexible body 1016 may have an approximately 3 mm outer diameter. Other flexible body outer diameters may be larger or smaller.

Medical instrument system 1000 may include the tracking system 1030 for determining the position, orientation, speed, velocity, pose, and/or shape of the flexible body 1016 at the distal end 1018 and/or of one or more segments 1024 along flexible body 1016, as will be described in further detail below. The tracking system 1030 may include one or more sensors and/or imaging devices. The flexible body 1016, such as the length between the distal end 1018 and the proximal end 1017, may include multiple segments 1024. The tracking system 1030 may be implemented using hardware, firmware, software, or a combination thereof. In some examples, the tracking system 1030 is part of control system 1012.

Tracking system 1030 may track the distal end 1018 and/or one or more of the segments 1024 of the flexible body 1016 using a shape sensor 1022 (e.g., a localization sensor). The shape sensor 1022 may include an optical fiber aligned with the flexible body 1016 (e.g., provided within an interior channel of the flexible body 1016 or mounted externally along the flexible body 1016). In some examples, the optical fiber may have a diameter of approximately 200 μm. In other examples, the diameter may be larger or smaller. The optical fiber of the shape sensor 1022 may form a fiber optic bend sensor for determining the shape of flexible body 1016. Optical fibers including Fiber Bragg Gratings (FBGs) may be used to provide strain measurements in structures in one or more dimensions. Various systems and methods for monitoring the shape and relative position of an optical fiber in three dimensions, which may be applicable in some embodiments, are described in U.S. Patent Application Publication No. 2006/0013523 (filed Jul. 13, 2005 and titled “Fiber optic position and shape sensing device and method relating thereto”); U.S. Pat. No. 7,772,541 (filed on Mar. 12, 2008 and titled “Fiber Optic Position and/or Shape Sensing Based on Rayleigh Scatter”); and U.S. Pat. No. 8,773,650 (filed on Sept. 2, 2010 and titled “Optical Position and/or Shape Sensing”), which are all incorporated by reference herein in their entireties. Sensors in some embodiments may employ other suitable strain sensing techniques, such as Rayleigh scattering, Raman scattering, Brillouin scattering, and Fluorescence scattering.

In some examples, the shape of the flexible body 1016 may be determined using other techniques. For example, a history of the position and/or pose of the distal end 1018 of the flexible body 1016 can be used to reconstruct the shape of flexible body 1016 over an interval of time (e.g., as the flexible body 1016 is advanced or retracted within a patient anatomy). In some examples, the tracking system 1030 may alternatively and/or additionally track the distal end 1018 of the flexible body 1016 using a position sensor system 1020. Position sensor system 1020 may be a component of an EM sensor system with the position sensor system 1020 including one or more position sensors. Although the position sensor system 1020 is shown as being near the distal end 1018 of the flexible body 1016 to track the distal end 1018, the number and location of the position sensors of the position sensor system 1020 may vary to track different regions along the flexible body 1016. In one example, the position sensors include conductive coils that may be subjected to an externally generated electromagnetic field. Each coil of position sensor system 1020 may produce an induced electrical signal having characteristics that depend on the position and orientation of the coil relative to the externally generated electromagnetic field. The position sensor system 1020 may measure one or more position coordinates and/or one or more orientation angles associated with one or more portions of flexible body 1016. In some examples, the position sensor system 1020 may be configured and positioned to measure six degrees of freedom, e.g., three position coordinates X, Y, Z and three orientation angles indicating pitch, yaw, and roll of a base point. In some examples, the position sensor system 1020 may be configured and positioned to measure five degrees of freedom, e.g., three position coordinates X, Y, Z and two orientation angles indicating pitch and yaw of a base point. Further description of a position sensor system, which may be applicable in some embodiments, is provided in U.S. Pat. No. 6,380,732 (filed Aug. 11, 1999 and titled “Six-Degree of Freedom Tracking System Having a Passive Transponder on the Object Being Tracked”), which is incorporated by reference herein in its entirety.

In some embodiments, the tracking system 1030 may alternately and/or additionally rely on a collection of pose, position, and/or orientation data stored for a point of an elongate device 1002 and/or medical tool 1026 captured during one or more cycles of alternating motion, such as breathing. This stored data may be used to develop shape information about the flexible body 1016. In some examples, a series of position sensors (not shown), such as EM sensors like the sensors in position sensor 1020 or some other type of position sensors may be positioned along the flexible body 1016 and used for shape sensing. In some examples, a history of data from one or more of these position sensors taken during a procedure may be used to represent the shape of elongate device 1002, particularly if an anatomic passageway is generally static.

FIG. 10B is a simplified diagram of the medical tool 1026 within the elongate device 1002 according to some embodiments. The flexible body 1016 of the elongate device 1002 may include the channel 1021 sized and shaped to receive the medical tool 1026. In some embodiments, the medical tool 1026 may be used for procedures such as diagnostics, imaging, surgery, biopsy, ablation, illumination, irrigation, suction, electroporation, etc. Medical tool 1026 can be deployed through channel 1021 of flexible body 1016 and operated at a procedural site within the anatomy. Medical tool 1026 may be, for example, an image capture probe, a biopsy tool (e.g., a needle, grasper, brush, etc.), an ablation tool (e.g., a laser ablation tool, radio frequency (RF) ablation tool, cryoablation tool, thermal ablation tool, heated liquid ablation tool, etc.), an electroporation tool, and/or another surgical, diagnostic, or therapeutic tool. In some examples, the medical tool 1026 may include an end effector having a single working member such as a scalpel, a blunt blade, an optical fiber, an electrode, and/or the like. Other end types of end effectors may include, for example, forceps, graspers, scissors, staplers, clip appliers, and/or the like. Other end effectors may further include electrically activated end effectors such as electrosurgical electrodes, transducers, sensors, and/or the like.

The medical tool 1026 may be a biopsy tool used to remove sample tissue or a sampling of cells from a target anatomic location. In some examples, the biopsy tool is a flexible needle. The biopsy tool may further include a sheath that can surround the flexible needle to protect the needle and interior surface of the channel 1021 when the biopsy tool is within the channel 1021. The medical tool 1026 may be an image capture probe that includes a distal portion with a stereoscopic or monoscopic camera that may be placed at or near the distal end 1018 of flexible body 1016 for capturing images (e.g., still or video images). The captured images may be processed by the visualization system 1031 for display and/or provided to the tracking system 1030 to support tracking of the distal end 1018 of the flexible body 1016 and/or one or more of the segments 1024 of the flexible body 1016. The image capture probe may include a cable for transmitting the captured image data that is coupled to an imaging device at the distal portion of the image capture probe. In some examples, the image capture probe may include a fiber-optic bundle, such as a fiberscope, that couples to a more proximal imaging device of the visualization system 1031. The image capture probe may be single-spectral or multi-spectral, for example, capturing image data in one or more of the visible, near-infrared, infrared, and/or ultraviolet spectrums. The image capture probe may also include one or more light emitters that provide illumination to facilitate image capture. In some examples, the image capture probe may use ultrasound, x-ray, fluoroscopy, CT, MRI, or other types of imaging technology.

In some examples, the image capture probe is inserted within the flexible body 1016 of the elongate device 1002 to facilitate visual navigation of the elongate device 1002 to a procedural site and then is replaced within the flexible body 1016 with another type of medical tool 1026 that performs the procedure. In some examples, the image capture probe may be within the flexible body 1016 of the elongate device 1002 along with another type of medical tool 1026 to facilitate simultaneous image capture and tissue intervention, such as within the same channel 1021 or in separate channels. A medical tool 1026 may be advanced from the opening of the channel 1021 to perform the procedure (or some other functionality) and then retracted back into the channel 1021 when the procedure is complete. The medical tool 1026 may be removed from the proximal end 1017 of the flexible body 1016 or from another optional instrument port (not shown) along flexible body 1016.

In some examples, the elongate device 1002 may include integrated imaging capability rather than utilize a removable image capture probe. For example, the imaging device (or fiber-optic bundle) and the light emitters may be located at the distal end 1018 of the elongate device 1002. The flexible body 1016 may include one or more dedicated channels that carry the cable(s) and/or optical fiber(s) between the distal end 1018 and the visualization system 1031. Here, the medical instrument system 1000 can perform simultaneous imaging and tool operations.

In some examples, the medical tool 1026 is capable of controllable articulation. The medical tool 1026 may house control members or cables (which may also be referred to as pull wires), linkages, or other actuation controls (not shown) that extend between its proximal and distal ends to controllably bend the distal end of medical tool 1026, such as discussed herein for the flexible elongate device 1002. The medical tool 1026 may be coupled to a drive unit 1004 and the manipulator assembly 902. In these examples, the elongate device 1002 may be excluded from the medical instrument system 1000 or may be a flexible device that does not have controllable articulation. Steerable instruments or tools, applicable in some embodiments, are further described in detail in U.S. Pat. No. 7,316,681 (filed on Oct. 4, 2005 and titled “Articulated Surgical Instrument for Performing Minimally Invasive Surgery with Enhanced Dexterity and Sensitivity”) and U.S. Pat. No. 9,259,274 (filed Sept. 30, 2008 and titled “Passive Preload and Capstan Drive for Surgical Instruments”), which are incorporated by reference herein in their entireties.

The flexible body 1016 of the elongate device 1002 may also or alternatively house cables, linkages, or other steering controls (not shown) that extend between the drive unit 1004 and the distal end 1018 to controllably bend the distal end 1018 as shown, for example, by broken dashed line depictions 1019 of the distal end 1018 in FIG. 10A. In some examples, at least four cables are used to provide independent up-down steering to control a pitch of the distal end 1018 and left-right steering to control a yaw of the distal end 1018. In these examples, the flexible elongate device 1002 may be a steerable catheter. Examples of steerable catheters, applicable in some embodiments, are described in detail in PCT Publication WO 2019/018736 (published Jan. 24, 2019 and titled “Flexible Elongated Device Systems and Methods”), which is incorporated by reference herein in its entirety.

In embodiments where the device 1002 and/or medical tool 1026 are actuated by a robot-assisted assembly (e.g., the manipulator assembly 902), the drive unit 1004 may include drive inputs that removably couple to and receive power from drive elements, such as actuators, of the robot-assisted assembly. In some examples, the elongate device 1002 and/or medical tool 1026 may include gripping features, manual actuators, or other components for manually controlling the motion of the elongate device 1002 and/or medical tool 1026. The elongate device 1002 may be steerable or, alternatively, the elongate device 1002 may be non-steerable with no integrated mechanism for operator control of the bending of distal end 1018. In some examples, one or more channels 1021 (which may also be referred to as lumens), through which medical tools 1026 can be deployed and used at a target anatomical location, may be defined by the interior walls of the flexible body 1016 of the elongate device 1002.

In some examples, the medical instrument system 1000 (e.g., the elongate device 1002 or medical tool 1026) may include a flexible bronchial instrument, such as a bronchoscope or bronchial catheter, for use in examination, diagnosis, biopsy, and/or treatment of a lung. The medical instrument system 1000 may also be suited for navigation and treatment of other tissues, via natural or surgically created connected passageways, in any of a variety of anatomic systems, including the colon, the intestines, the kidneys and kidney calices, the brain, the heart, the circulatory system including vasculature, and/or the like.

The information from the tracking system 1030 may be sent to the navigation system 1032, where the information may be combined with information from the visualization system 1031 and/or pre-operatively obtained models to provide the physician, clinician, surgeon, or other operator with real-time position information. In some examples, the real-time position information may be displayed on the display system 910 for use in the control of the medical instrument system 1000. In some examples, the navigation system 1032 may utilize the position information as feedback for positioning medical instrument system 1000. Various systems for using fiber optic sensors to register and display a surgical instrument with surgical images, applicable in some embodiments, are provided in U.S. Pat. No. 8,900,131 (filed May 13, 2011 and titled “Medical System Providing Dynamic Registration of a Model of an Anatomic Structure for Image-Guided Surgery”), which is incorporated by reference herein in its entirety.

In the description, specific details have been set forth describing some examples. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure.

Elements described in detail with reference to one example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the following description, one or more elements shown and described in association with one example, implementation, or application may be incorporated into other examples, implementations, or aspects unless specifically described otherwise, unless the one or more elements would make an example or implementation non-functional, or unless two or more of the elements provide conflicting functions.

Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure. In addition, dimensions provided herein are for specific examples and it is contemplated that different sizes, dimensions, and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The systems and methods described herein may be suited for imaging, via natural or surgically created connected passageways, in any of a variety of anatomic systems, including the lung, colon, the intestines, the stomach, the liver, the kidneys and kidney calices, the brain, the heart, the circulatory system including vasculature, and/or the like. While some examples are provided herein with respect to medical procedures, any reference to medical or surgical instruments and medical or surgical methods is non-limiting. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy) and performing procedures on human or animal cadavers. Further, these techniques can also be used for surgical and nonsurgical medical treatment or diagnosis procedures.

The methods (e.g., 500, 600, 700) described herein are illustrated as a set of operations or processes that may be performed in the same or in a different order than the order shown. One or more of the illustrated processes may be omitted in some examples of the method. Additionally, one or more processes that are not expressly illustrated in FIGS. 3, 5, 10, and 12 may be included before, after, in between, or as part of the illustrated processes. Further, processes of any of the methods may be used in another of the methods, even if not expressly stated. In some examples, one or more of the processes of the methods may be implemented, at least in part, by the control system (e.g., the control system 912) executing code stored on non-transitory, tangible, machine-readable media that when run by one or more processors (e.g., the processors 914 of the control system 912) may cause the one or more processors to perform one or more of the processes.

One or more components of the embodiments discussed in this disclosure, such as control system 912, may be implemented in software for execution on one or more processors of a computer system. The software may include code that when executed by the one or more processors, configures the one or more processors to perform various functionalities as discussed herein. The code may be stored in a non-transitory computer readable storage medium (e.g., a memory, magnetic storage, optical storage, solid-state storage, etc.). The computer readable storage medium may be part of a computer readable storage device, such as an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code may be downloaded via computer networks such as the Internet, Intranet, etc. for storage on the computer readable storage medium. The code may be executed by any of a wide variety of centralized or distributed data processing architectures. The programmed instructions of the code may be implemented as a number of separate programs or subroutines, or they may be integrated into a number of other aspects of the systems described herein. The components of the computing systems discussed herein may be connected using wired and/or wireless connections. In some examples, the wireless connections may use wireless communication protocols such as Bluetooth, near-field communication (NFC), Infrared Data Association (IrDA), home radio frequency (HomeRF), IEEE 802.11, Digital Enhanced Cordless Telecommunications (DECT), and wireless medical telemetry service (WMTS).

Note that the processes and displays presented may not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the examples of the invention are not described with reference to any particular programming language. It will be appreciated that a variety of programming languages may be used to implement the teachings of the invention as described herein.

In some instances well known methods, procedures, components, and circuits have not been described in detail so as not to unnecessarily obscure aspects of the examples. This disclosure describes various instruments, portions of instruments, and anatomic structures in terms of their state in three-dimensional space. As used herein, the term “position” refers to the location of an object or a portion of an object in a three-dimensional space (e.g., three degrees of translational freedom along Cartesian x-, y-, and z-coordinates). As used herein, the term “orientation” refers to the rotational placement of an object or a portion of an object (three degrees of rotational freedom-e.g., roll, pitch, and yaw). As used herein, the term “pose” refers to the position of an object or a portion of an object in at least one degree of translational freedom and to the orientation of that object or portion of the object in at least one degree of rotational freedom (up to six total degrees of freedom). As used herein, the term “shape” refers to a set of poses, positions, or orientations measured along an object. As used herein, the term “distal” refers to a position that is closer to a procedural site and the term “proximal” refers to a position that is further from the procedural site. Accordingly, the distal portion or distal end of an instrument is closer to a procedural site than a proximal portion or proximal end of the instrument when the instrument is being used as designed to perform a procedure.

While certain illustrative examples of the invention have been described and shown in the accompanying drawings, it is to be understood that such examples are merely illustrative of and not restrictive on the broad invention, and that the examples of the invention not be limited to the specific constructions and arrangements shown and described, since various other alternatives, modifications, and equivalents will be appreciated by those with ordinary skill in the art.

1. A system comprising:
a flexible elongate device including a working channel;
a radial acoustic imaging tool extendable within the working channel and rotationally constrained relative to the flexible elongate device by a reference mechanism, the radial acoustic imaging tool including a directional indicator; and
a controller configured to:
receive an acoustic image of a region of interest from the radial acoustic imaging tool, wherein the acoustic image includes an image of the directional indicator,
dynamically search the acoustic image to identify the image of the directional indicator,
determine a rotational adjustment of the acoustic image to align the image of the directional indicator relative to the reference mechanism, and
display the acoustic image with the rotational adjustment.

2. The system of claim 1, wherein the reference mechanism incudes a device key feature of the flexible elongate device engageable with a tool key feature of the radial acoustic imaging tool to constrain rotational motion of the radial acoustic imaging tool relative to the flexible elongate device.

3. The system of claim 2, wherein the tool key feature is located along a proximal portion of the radial acoustic imaging tool.

4. The system of claim 2, wherein the tool key feature is located along a distal portion of the radial acoustic imaging tool.

5. The system of claim 1, wherein the radial acoustic imaging tool includes a radially movable transducer assembly and a jacket extending over the radially movable transducer assembly, wherein the directional indicator includes an elongated marker on the jacket.

6. The system of claim 1, wherein the directional indicator has a fixed orientation relative to the reference mechanism.

7. The system of claim 1, wherein the acoustic image includes video acoustic image data and dynamically searching the acoustic image includes searching the video acoustic image data as the radial acoustic imaging tool changes position and/or orientation.

8. The system of claim 1, wherein dynamically searching the acoustic image to identify the directional indicator includes conducting an image analysis of the acoustic image.

9. The system of claim 1, wherein the flexible elongate device includes an articulation system with a known configuration in a frame of reference of the flexible elongate device.

10. The system of claim 1, wherein the controller is further configured to register an image frame of reference for the acoustic image to a frame of reference of the flexible elongate device.

11. The system of claim 1, wherein the controller is further configured to identify a target region of a lesion visible in the acoustic image.

12. The system of claim 11, wherein identifying the target region of the lesion includes receiving an operator identification of the target region of the lesion.

13. The system of claim 11, wherein identifying the target region of the lesion includes conducting an image analysis of the acoustic image.

14. (canceled)

15. The system of claim 11, wherein the controller is further configured to determine a location of the target region relative to the flexible elongate device.

16. The system of claim 15, wherein the controller is further configured to articulate a distal end portion of the flexible elongate device based on the determined location of the target region.

17. The system of claim 16, wherein the working channel of the flexible elongate device is sized to receive an interventional tool deployable from the articulated distal end portion of the flexible elongate device toward the target region.

18. The system of claim 11, wherein the controller is further configured to update a planned target location in an anatomic model based on the identified target region.

19. The system of claim 18, wherein the controller is further configured to:
display the anatomic model with the updated planned target location.

20. The system of claim 19, wherein the controller is further configured to:
determine an insertion distance of the radial acoustic imaging tool relative to the flexible elongate device.

21. The system of claim 11, wherein displaying the acoustic image includes displaying an interventional marker at the identified target region.

22-63. (canceled)
